(19) United States
(12) Patent Application Publication
(10) Pub. No.: US 2018/0008076 A1
(43) Pub. Date: Jan. 11, 2018

(54) Smart Mailbox Device

(71) Applicants: Mahasweta Mitra, Santa Clara, CA (US); Swapnajit Mitra, Santa Clara, CA (US)

(72) Inventors: Mahasweta Mitra, Santa Clara, CA (US); Swapnajit Mitra, Santa Clara, CA (US)

(21) Appl. No.: 15/203,465

(22) Filed: Jul. 6, 2016

(51) Int. Cl. A47G 29/122; H04L 12/58

(52) U.S. Cl. CPC A47G 29/1225; H04L 51/30; H04L 51/24; A47G 2029/1226

(57) ABSTRACT

A smart mailbox system capable of electronically communicating the receipt of mail and the collection of mail to an end user. User authentication allows the mailbox to communicate the identity of the user who collects the mail. The mailbox also images the mail so as to provide a record of the receipt of specific pieces of mail and to permit the user to visually see the collected mail without having to go to the mailbox. The identity of the sender and recipient are made available through the system. The system is also networkable so as to join multiple mailboxes within the same network.

### CROSS REFERENCE TO RELATED APPLICATIONS

This application claims priority from U.S. Provisional Patent Application 62/189,751 filed on Jul. 8, 2016.

### BACKGROUND

### 1. Art Field

This application relates to any secure container capable of exchanging stored physical objects between two authenticated parties. Particularly, this application discloses a method and system for a mailbox, or any mailbox like device such as key deposit box, that may be used as a temporary secure storage vault for physical exchange of objects by authenticated users. More particularly, this application relates to a mailbox, or any mailbox like device such as key deposit box, that may be used as a temporary secure storage vault for physical exchange of objects by authenticated users capable of communicating its status over internet.

### 2. Related Art

Computing has become all-pervasive due to decreased cost of computing devices. Beyond their traditional application as server, desktop and mobile devices, computers and central processing units (CPUs) can be found in many consumer products as embedded devices, such as, cars, game consoles, smart electric meters, and many other smart home appliances and equipment. In the field of computer science, the term ‘ubiquitous computing’ generally refers to computing needs and methods, where computers and CPUs are utilized in everyday application.

A paradigm in which the computers employed in ubiquitous computing communicate with each other over the internet is generally called ‘Internet of Things’ (IoT) or ‘Internet of Everything’ (IoE). An important component of the IoT paradigm is the human-computer interface, where the status from one or more computing devices in common household items is sent for human observation, monitoring or further input.

A mailbox is a common household item (each house with an address has one) that has been used for centuries for secured disposal or acceptance of mails and other parcels. The concept of mailbox has been used for other purposes as well, such as, exchanging keys, cash or documents among workers of two consecutive shifts. However, there is no direct way for a mailbox to alert the recipient that an object is waiting for retrieval, nor to send any acknowledgement to the sender of the item when the item is retrieved.

Traditionally, when a letter or mail is delivered in a traditional mailbox, the postman raises the flag of the mailbox, if one is available, indicating that the mailbox has received mail. Observing the position of the flag from a distance saves the owner an unnecessary trip to the mailbox and the effort of opening it if there has been no mail received that day. Moreover, the burden falls on the owner of the mailbox to remember to reset the mailbox status, i.e. manually lowering the flag, after removing all mails so that the postal carrier can trigger the status change, i.e. raise the flag, upon the next delivery.

This primitive form of physical mail exchange has worked well for many years. However, there are several obvious drawbacks to this process. First, the owner needs to be in the line of sight of the mailbox to see the status of the flag. That may not always be easily achieved from the comfort of one's home. For example, a mailbox in rural areas, may be located in a place easily accessible by the postal service but at a distance from the home it is associated with and not within the line of sight from the home. Coming out of the home and reaching a line of sight point for the purpose of checking the status of the flag is an inconvenience to the recipient, especially during inclement weather. Also, the recipient may not be at home, e.g. traveling or at work, and may still want to know whether mail has been received or, for example, if a specific mail has been delivered on that day. Furthermore, a commercial mailbox is kept at a facility owned by the business. The user of the mailbox has no way to know if and which mail has been delivered to the mailbox without making a trip to the location of the mailbox and opening it.

Another drawback of the current process is that even if the owner knows one or more pieces of mail have been delivered from a raised flag, there is no way to know which specific piece of mail has been delivered. The owner still needs to make a trip to the mailbox to learn the identity of the sender and estimate the priority of retrieving the piece of mail. If a piece of mail is not important enough to be immediately collected, the owner still needs to be physically present to open the mailbox so as to inspect the item.

A further drawback of the current process is that there is no automated logging of received pieces of mail. Situations where automatic logging of incoming mails is useful are where an owner of a mailbox may need to keep track of the incoming log for business, legal or reminder purposes. Also, a mailbox may have more than one owner (spouses, roommates, business partners, etc.). One owner may see the flag and take the pieces of mail out without the knowledge of other(s). It is currently not possible for all of them to be notified when/if a piece of mail arrives.

An additional drawback of the current process is that there is no further reminder possible if a piece of mail has arrived but has not been picked up for certain time unless the owner chances upon the red flag again.

A further drawback of the current process is that the sender of a piece of mail never receives any automatic acknowledgement when the mail is delivered or retrieved, unless an external or sideband service, such as, signature confirmation, is used.

### SUMMARY

The present application discloses a smart mailbox with the capability to communicate the occurrence of events of interest to end users.

### BRIEF DESCRIPTION OF THE DRAWINGS

FIG. 1 is a side view of the internal structure of a mailbox, illustrating various components and interfaces, in accordance with a preferred embodiment.

FIG. 2 is the flowchart of the process for mail delivery in one embodiment of the device of the present application.

FIG. 3 is the flowchart of the process for the collection of mail in one embodiment of the device of the present application.

FIG. 4 is the schematic representation of various components of the software system in accordance with an embodiment of the device of the present application.

### DETAILED DESCRIPTION

Reference will now be made in detail to specific embodiments of the device 100 of the present application including the contemplated best modes. Examples of these specific embodiments are illustrated in the accompanying drawings. While the device 100 of the present application is described in conjunction with these specific embodiments, it will be understood that it is not intended to be limited to the described embodiments. On the contrary, it is intended to cover alternatives, modifications, and equivalents as may be included within the spirit and scope of the application as defined by the appended claims. In the following description, specific details are set forth in order to provide a thorough understanding of the device. The disclosed device and methods may be practiced without some or all of these specific details. In addition, well known features may not have been described in detail to avoid unnecessary obscuring of the scope of the application.

In accordance with the present application, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The system of the present application may also be tangibly embodied as a set of computer instructions stored on a computer readable medium, such as a memory device.

It should be noted that the terms “Internet of Things”, “Internet of Everything” and “IoT” as used in the present document shall be construed broadly and in line with common usage in the computer software field. Specifically, when describing an IoT enabled computing device, it is recognized that the term IoT shall include any communication protocol, including but not limited to, protocol that can be carried out over internet.

It should also be noted that the term “mailbox” as used in the present application shall be construed broadly to mean any secured or unsecured physical storage device that can be used for exchanging physical objects between two parties. This can include traditional mailboxes, as used for delivering and receiving postal mails, but it can also include more generic usages of such a storage or holding place for any object. For example, the system can be applied to key boxes, drop boxes, cash vaults, document boxes, etc.

In a preferred embodiment, a process is provided that lets a receptacle 100 detect when an object is deposited and communicate this status to a central server.

In a preferred embodiment, a process is provided that lets the aforementioned server 200 communicate this status to one or more end users. The status may be communicated in the form of text, image or any other form of electronic communication. The status may include an image of the object that has been delivered but has not been retrieved.

In a preferred embodiment, a process is provided that lets a server communicate periodic reminder to one or more end users when a previously deposited object has not been retrieved for longer than a preset amount of time.

In a preferred embodiment, a process is provided that lets a mailbox 100 detect when a previously deposited object is retrieved and communicate this status to a central server.

In a preferred embodiment, a process is provided for individual electronically secured access to the mailbox 100 for retrieving purposes.

In a preferred embodiment, a process is provided that lets a server 200 communicate a notification of the event of retrieval of object from the mailbox 100 to other co-users of the same mailbox.

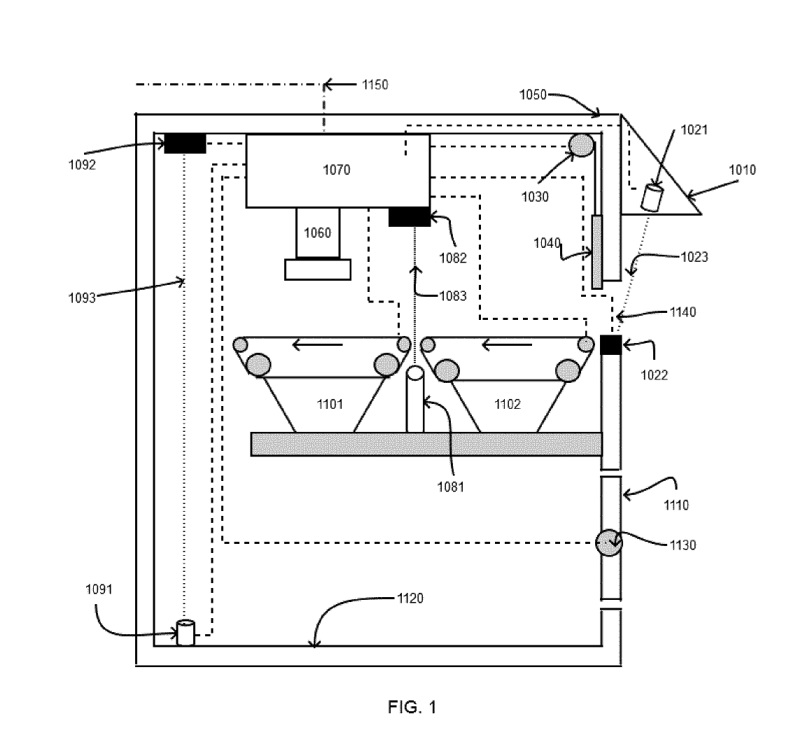

FIG. 1 is the side view of the internal structure of a mailbox 100 in accordance to a preferred embodiment illustrating various components and interfaces. One of ordinary skill in the art will recognize that this is merely an example, and that there may be other ways of handling steps in mail delivery process that can be implemented in keeping with the spirit of the disclosure.

In one embodiment of the system, the interfaces to the outside environment can be broadly categorized as (1) physical interface 350 and (2) electronic interface 400. In an additional embodiment of the system, the physical interface 300 possesses an entry slot 1140 through which letters are inserted into the mailbox 100. The slot 1140 is configured so as to permit the entry of mail but to inhibit its removal back through the entry slot 1140 so as to prevent mail theft. In a preferred embodiment, a motorized mechanical gate 1040 protects the slot 1140 and opens only when a sensor # detects a piece of mail being inserted through the slot 1140 and sends a signal to the motor 1030. The gate 1040, normally closed, helps to protect the internal electronic circuitry from outside dust and other environmental contaminants.

In one embodiment of the system, the mailbox 100 further consists of securable collection door 1110, large enough for the owner to access the pieces of mail deposited inside the mailbox 100 and remove then remove them.

In a preferred embodiment, the slot 1140 is protected by password entered through an electronic interface 400 which controls the gate 1040. In a further embodiment, multiple passwords are utilized for end user authentication.

In a preferred embodiment, the internal IoT Processing Unit 1070, i.e. IPU, that connects to various internal components of the electronic interface 400. These communications are indicated by the dashed lines in FIG. 1. A data connection 1150 between the IPU 1070 and a back-end server 200 conveys various control and status data. In a further embodiment, the data connection 1150 is an IoT compliant connection.

In a preferred embodiment, various sensor systems 1021, 1022, 1081, 1082, 1091, and 1092 are used for detecting current system status and then communicating it electronically to the IPU 1070. These sensor transmitter and receiver pairs 1021, 1022 and 1081, 1082 and 1091, 1092 are preferably simple infrared transmitter/receiver pairs, but this does not preclude the use of any other form of sensors with achieve similar results. As an example, a first infrared transmitter 1021 sends a first infra-red light beam 1023 to a first infrared receiver 1022. If there is no object that interrupts the first infrared beam 1023 between the first infrared transmitter 1021 and the first infrared receiver 1022, the first light beam 1023 reaches the infrared receiver 1022 unobstructed. However, when there is an obstruction, the first light beam 1023 does not reach the infrared receiver 1022. The obstruction of the infrared beam to the first infrared receiver 1022 is a reportable event as is the receipt of the first infrared beam 1023. The status of the first infrared beam 1023 is reported to the IPU 1070 for processing, as is the status of the second infrared beam 1083 and the third infrared beam 1093. A second infrared transmitter 1081 transmits a second infrared beam 1083 to a second infrared receiver 1082 to act within the receptacle 100 to trigger the imaging sequence of the incoming piece of mail. A third infrared transmitter 1091 transmits a third infrared beam 1083 to a third infrared receiver 1092 act within the mailbox 100 and is placed after the imaging of the piece of mail to trigger record the entry of the piece of mail into a collection compartment 1120.

In a preferred embodiment, the operation of the device 100 described in the present application can be divided into two main parts—item reception and item removal. In a preferred embodiment, it is assumed that one piece of mail at a time would be inserted through the entry slot 1140 while the deliverer is instructed to orient the piece of mail to facilitate imaging 2050 by the imaging system 1060. It will be understood that this assumption is not intended to limit the device to the described embodiments and that dual imaging systems 1080 may be utilized to image 2050 the top and bottom faces of a piece of mail.

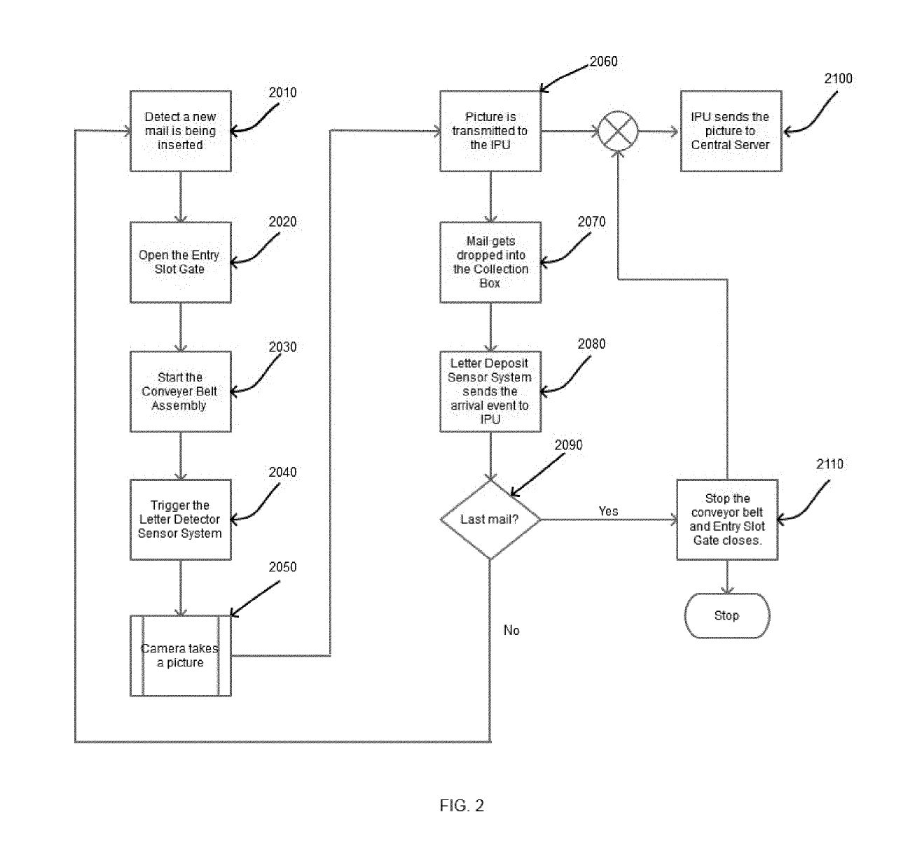

The item receiving process, as depicted in flow diagram FIG. 2, illustrates a method for an item to be received into the receptacle. One of ordinary skill in the art will recognize that this is merely an example, and that there may be other ways of receiving an item which can be implemented while keeping with the spirit of the disclosure. The receptacle 100 utilizes an item receiving process 2010 which detects if a piece of mail is approaching the entry slot 1140 and triggers the receptacle 100 to begin to receive and image 2050 incoming items.

In FIG. 2, the item receiving process 2010 triggers the opening of the entry slot gate 1040 that is normally closed but is actuated by the interruption of the infrared signal to the first infrared receiver 1022. The item receiving process 2010 triggers the actuation of the motor assembly 1030 which controls the opening of the entry slot gate 1040.

The conveying process 2030 utilizing the first conveyer belt assembly 1101 and second conveyor belt assembly 1102 is triggered by the item receiving process 2010 and conveys the incoming mail toward the imaging apparatus 1060. A letter detector system 2040 utilizing the second infrared sensors 1081, 1082 associated with the imaging apparatus 1060 actuates the letter imaging event 2050 while the letter is within the imaging field of the imaging apparatus 1060.

The Letter Detector sensor system activates the Camera at 1060 of FIG. 1. During the imaging process 2050 the letter is momentarily stopped as the Camera takes a picture of the face of the letter showing the addressee, and possibly the sender information. The imaging process 2050 is followed by an imaging transmission process 2060 to the IPU 1070. At suitable time, the image is communicated from the IPU 1070 to the server 200 using the data communication connection 1150. This is followed by the collection process 2070 during which the letter is dropped into the collection compartment 1120 by the second conveyor belt assembly 1101. The letter collection process 2080 is triggered by the interruption of the third infrared signal 1083 to the third infrared receiver 1082.

The collection process 2080 is followed by a last letter calculation 2090, preferably the result of a timer. Steps 2010 through 2080 are repeated the last letter calculation ends in a positive result at which time the receptacle 100 enters a sleep mode to conserve power.

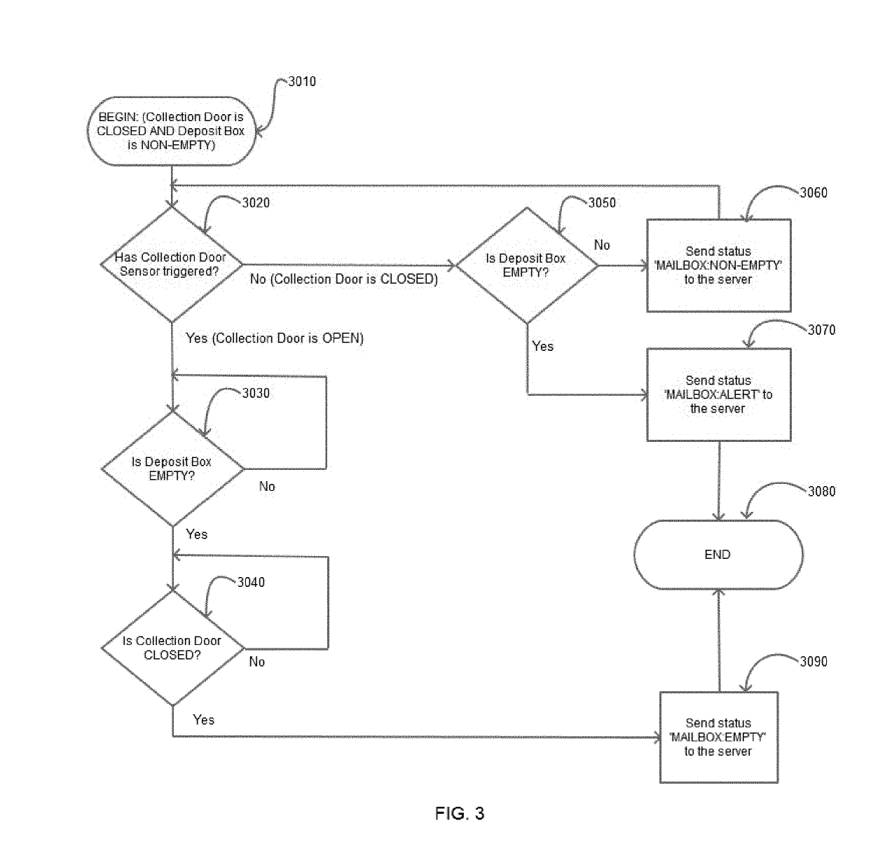

FIG. 3 depicts the item collection process from a mailbox as envisioned by the device 100 described in the present application. The mail removal process 3010 begins as the collection door 1110 that the mailbox owner opens to take the arrived mails out. The Collection Door Sensor at 1130 of FIG. 1 is associated with the Collection Door and determines the current state (open, close) of the door and conveys that information to the IPU at 1070 of FIG. 1. In a preferred embodiment, the collection door may be actuated manually and is protected by a manual lock. A collection decision 3020 indicates whether the collection door 1110 has been opened. As previously discussed, the collection door 1110 actuation can be password protected.

In a preferred embodiment, the owner collects the pieces of mail from the collection compartment 1120. The letter deposit sensors 1091, 1092 detect whether the collection compartment 1120 is empty and relays that information to the IPU 1070. As the next step of the collection process, a collection decision 3030 is made to indicate whether the collection compartment 1120 is empty and this status is reported to the server 300. In the last step the collection process, a collection door status calculation 3040 indicates whether the collection door 1110 is closed or open.

The processes envisioned by the collection process previously described also indicate exception situations. If the collection door 1120 is never opened but a non-empty Deposit Box turns empty, an alert process 3070 sends an alert message to the server to warn of possible mail theft or similar aberration. It should be noted that the IPU 1070 acts as the central processing unit for all processes and calculations.

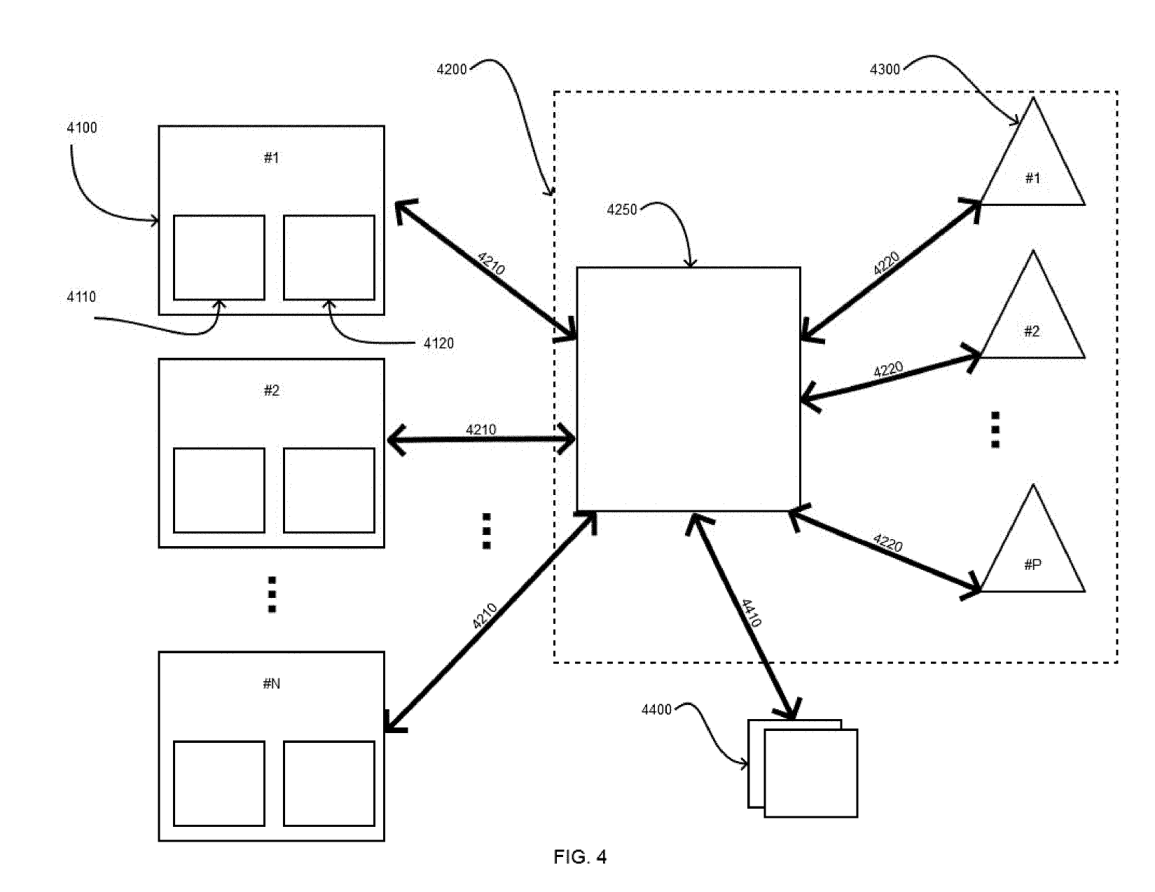

FIG. 4 is the schematic representation of the device's 100 software system architecture as envisioned in the present application. The IPU software unit 4100 is located and run on the IPU 1070 in a device 100 envisioned by this disclosure. The central back-end service module 4200 that runs on a central server 300. It is envisioned that a number of IPU software units 4100 will be connected to the central back-end service module 4200. The actual number of mailboxes, shown as N in FIG. 4, connected to the central back-end service module 4200 will depend on the server 300 strength and load. The central back-end service module 4200 consists of the IPU interface manager 4250 and various software agents 4300. Each software agent 4300 has a pre-specified task. Once the status from an IPU software unit 4100 is received, each software agent pulls this information from the IPU interface manager 4250 as a client to perform its assigned task. For example, a particular type of status message may be handled by one or more specific software agents 4300 which process this data independently. It will be understood that the number, responsibilities and the protocol of communication between the software agents and the IPU interface manager 4250 can be implemented in various ways keeping the spirit of the disclosure. A plurality of individual software agents 4300 are responsible for initiating a request and then processing the response from the IPU interface manager 4250. The software agents 4300 are responsible for monitoring the said responses received by other agents, for storing usage data of the responding mailboxes and for deriving analytical conclusions processing these usage data. The IPU interface manager 4250 acts as a conduit between the IPU software units of all mailboxes connected to this server 300 and all software agents 4300. These communications are shown as 4210 and 4220. Furthermore, the IPU interface manager 4250 is capable of communicating to the registered devices of the recipients or owners of the mailboxes at 4400. Such communications are shown at 4410.

In its simplest form, only one central back-end service module 4200 is connected to multiple IPUs 1070. However, it will be understood that an architecture that employs clusters of central back-end service modules 4200 communicating with each other for load balancing, geographical distribution of work, quality of service maintenance or other purposes can be implemented keeping with the spirit of this disclosure.

There are multiple ways to implement the software architecture. In an embodiment, the software architecture may take the form of an MQTT type publisher-subscriber architecture, where each IPU 1070 will be a publisher, the IPU interface manager 4250 will be the broker and the software agents 4300 taking action on the messages published from any unit of IPU 1070 will be the subscriber.

Operation of each instance of the IPU software unit 4100 located in individual mailbox 100 can be divided into two major parts. The control software manager 4110 closely monitors and takes action on all hardware operations of a mailbox 100 envisioned by this application. The IPU software unit 4100 also possesses a server interface manager software module 4120.

In a preferred embodiment, when the input from the first infrared sensors 1021, 1022 indicates the arrival of new mail the control software manager 4110 interfaces with the entry slot gate motor 1030 to operate the entry slot gate 1040.

In a further preferred embodiment, the control software manager 4110 starts and stops the first and second conveyer belt assemblies 1101, 1102 as it carries letters past the imaging apparatus 1060 and drops them into the collection compartment 1120.

In a preferred embodiment, the control software manager 4110 also stops the when the second infrared sensors 1081, 1082 are triggered and then instructs the imaging apparatus 1060 to image 2050 the letter before starting the second conveyer belt assembly 1101 again.

In a preferred embodiment, the control software manager 4110 receives input from the third infrared sensors 1091, 1092 that indicates that the collection compartment 1120 is empty or not.

In a preferred embodiment, the control software manager 4110 also receives open/close state information of the collection door 1110 from the collection door sensor at 1130.

In one embodiment of the server interface manager part of the IPU software unit 4100, each mailbox 100 is identified by a unique ID, henceforth referred to as MID.

In one embodiment of the server interface manager, each mailbox 100 communicates with the central back-end service module 4200.

In a preferred embodiment, the aforementioned communication contains, among other fields, an MID, a message type and the contents.

In a preferred embodiment, the server interface manager sends a message of message type ‘Heartbeat’ to its allocated central back-end service module 4200 at a regular interval (for example, once a day). The non-arrival of the heartbeat message indicates something is wrong with the mailbox associated with that non-reporting IPU software unit 4100.

In a preferred embodiment, with the arrival of one or more new pieces of mail, server interface manager sends a message, identified by the MID, to its connected Central Backend Service Module with the Message Type set to ‘New Mail’.

In a preferred embodiment, when the server interface manager sends a message with message type set to ‘New Mail’, it attaches individual photographs of the pieces of mail to the connected central back-end service module 4200.

In various embodiments of the disclosure, the server interface manager communicates various reminder services to the connected central back-end service module 4200.

In an embodiment, the Server Interface Manager sends a message to the connected central back-end service module 4200 with a message type set to ‘Mailbox Non-empty’ at an interval set by the users.

In an embodiment of the system, if the Control Software Manager of a mailbox envisioned by the device 100 described in the present application detects the following sequence of events: (mailbox is non-empty and the mailbox door is closed, mailbox door is open, mailbox is empty and mailbox door is close), then the Server Interface Manager sends a message to the Central Backend Service Module with Message type set to ‘Mailbox Empty’.

In an embodiment of the system, if the control software manager 4110 described in the present application detects the following sequence of events: (mailbox 100 is non-empty and the mailbox door 1110 is closed, mailbox 1100 is empty and mailbox door 1110 is closed), the server interface manager sends a message to the central backend service module 4200 with message type set to ‘Alert’.

In a preferred embodiment, the central backend service module 4200 identifies a connected mailbox 100 by its unique MID when it receives a message from that mailbox 100.

In a preferred embodiment, the central backend service module 4200 has a list of associated emails and phone numbers for each MID.

In a preferred embodiment, when a message arrives to the central backend service module 4200 from one of the connected mailboxes and the Message Type is ‘New Mail’, it sends email and/or automated voice call to the recipients. If one or more images accompany the message from the mailbox, the central backend service module 4200 also sends links to these images to the recipients.

In a preferred embodiment, the Central Backend Service Module has optical character recognition (OCR) capability in one of the Software Agents to read contents written on the envelopes from the received image of a piece of mail.

In a preferred embodiment, when a message arrives to the central backend service module 4200 from one of the connected mailboxes 100 and the Message Type is ‘Mailbox Non-empty’, the central backend service module 4200 sends email or voice mail reminder to the recipients associated with the MID for picking up the mail.

In a preferred embodiment, when a message arrives to the central backend service module 4200 from one of the connected mailboxes and the Message Type is ‘Mailbox Empty’, the server 300 stops sending any message reminder.

In a preferred embodiment, when a message arrives to the central backend service module 4200 from one of the connected mailboxes 100 and the message type is ‘Alert’, the server 300 sends alert messages to the registered devices of the recipient or additional people who may attend to the situation immediately.

In a preferred embodiment, when a message arrives to the central backend service module 4200 from one of the connected mailboxes 100 and the message type ‘Heartbeat’ has not arrived for more than the expected heartbeat message period, the server 300 sends a diagnostic message to the service team on the health concern of that particular mailbox 100.

In a preferred embodiment, there may be more than one central backend service module 4200, each of which may communicate with another such server 300 for load balancing, geographical distribution of work, quality of service maintenance or other purposes.

It should also be noted that any of the steps of the algorithms and processes described above may be embodied in hardware or software, or any combination thereof. In a software embodiment, one or more of the components are designed as programmable computer instructions executable by a machine, such as a computer processor, the instructions stored in a computer readable medium.

While the device 100 and processes of the present application have been particularly shown and described with reference to specific embodiments thereof, it will be understood by those skilled in the art that changes in the form and details of the disclosed embodiments may be made without departing from the spirit or scope of the application. In addition, although various advantages, aspects, and objects of the device 100 and processes of the present application have been discussed herein with reference to various embodiments, it will be understood that the scope of the application should not be limited by reference to such advantages, aspects, and objects. Rather, the scope of the application should be determined with reference to the appended claims.

What is claimed is:

1. A mailbox system for receiving items comprising:
a. a receptacle housing having an item entry port and an item exit port, said entry port and being sealed by an entry door and said exit port being sealed by an exit door;
b. a first sensor system placed in front of said entry port to detect an attempt to place an item in said receptacle housing;
c. a means to image said item as it is received, said means to image said item being actuated by a second sensor system;
d. a collection compartment where said item is stored, said collection compartment being accessible via said exit port;
e. a third sensor system to detect when items are stored in said collection compartment;
f. a central processing unit to control said receptacle, computer memory, and computer readable media;
g. means to communicate the receipt of items into said receptacle to a remote user;
h. means to communicate an image of items received into said receptacle to a remote user;
i. means to communicate the storage of items received into said collection compartment of said receptacle to a remote user;
j. means to communicate the removal of items housed within said receptacle to a remote user; and
k. means to communicate the operational status of said receptacle to a remote user.

2. The mailbox system of claim 1, further comprising at least one conveyor belt system to convey the incoming item within said receptacle to an imaging apparatus.

3. The mailbox system of claim 1, where said central processing unit communicates with a remote server using a computer network protocol.

4. The mailbox system of claim 1, wherein the entry door of said receptacle opens automatically when said first sensor system is triggered.

5. The mailbox system of claim 2, wherein the movement of said at least one conveyor belt system is paused when triggered by said second sensor system so as to make said received item stationary relative to said imaging system while within the imaging field of said imaging apparatus.

6. The mailbox system of claim 1, wherein said imaging apparatus communicates image data to said central processing unit which facilitates the transmission of said image data to a server for retrieval by an end user.

7. The mailbox system of claim 1, wherein said server communicates electronic notices of the receipt and collection of receptacle housed items to the end users of said receptacle.

8. The mailbox system of claim 1, where said exit door is secured.

9. The mailbox system of claim 8, wherein a user is electronically authenticated prior to receiving access to the receptacle interior and a database of authorized end users is stored on said computer readable memory.

10. The mailbox system of claim 9, wherein a receptacle access log is maintained on said computer readable memory.

11. The mailbox system of claim 6, wherein a database of images of said items received by said receptacle are stored and accessible on said server.

12. The mailbox system of claim 11, wherein said images of mail in said database are associated with data identifying the recipient and with data identifying the sender.

13. The mailbox system of claim 12, where said receptacle is one of a networked plurality of said receptacles.

14. A networked mailbox system comprising:
a. a receptacle housing having an item entry port and an item exit port, said entry port and being sealed by an entry door and said exit port being sealed by an exit door;
b. a first sensor system placed in front of said entry port to detect an attempt to place mail in said receptacle housing;
c. a means to image said mail as it is received, said means to image said mail being actuated by a second sensor system;
d. a collection compartment where said mail is stored, said collection compartment being accessible via said exit port;
e. a third sensor system to detect when mail is stored in said collection compartment;
f. a central processing unit, computer memory, and computer readable media;
g. a server remote from and in electronic communication with said receptacle;
h. means to communicate the receipt of mail into said receptacle to a remote user via said server;
i. means to convey said mail to said imaging apparatus;
j. means to communicate an image of mail received into said receptacle to a remote user via said server;
k. means to communicate the storage of mail received into said collection compartment of said receptacle to a remote user via said server;
l. means to communicate the removal of mail housed within said receptacle to a remote user via said server; and
m. means to communicate the operational status of said receptacle to a remote user via said server.
n. wherein the entry door of said receptacle opens automatically when said first sensor system is triggered.

15. The networked mailbox system of claim 14, wherein the movement of said at least one conveyor belt system is paused when triggered by said second sensor system so as to make said received item stationary relative to said imaging system while within the imaging field of said imaging apparatus.

16. The networked mailbox system of claim 14, wherein said imaging apparatus communicates image data to said central processing unit which facilitates the transmission of said image data to said server for retrieval by an end user and wherein said server communicates electronic notices of the receipt and collection of receptacle housed items to the end users of said receptacle.

17. The networked mailbox system of claim 14, where said exit door is secured and a user is electronically authenticated prior to receiving access to the receptacle interior from a database of authorized end users is stored on said computer readable memory and a mailbox access log is maintained on said computer readable memory.

18. The networked mailbox system of claim 16, wherein a database of images of said items received by said receptacle are stored and accessible on said server for communication to an end user and said images of mail in said database are associated with data identifying the recipient and with data identifying the sender.

19. The networked mailbox system of claim 14 where said receptacle is one of a networked plurality of said receptacles.

20. A networked mailbox system comprising:
a. at least one receptacle, said receptacle having an item entry port and an item exit port, said entry port and being sealed by an entry door and said exit port being sealed by an exit door;
b. a first sensor system placed in front of said entry port to detect an attempt to place mail in said receptacle housing;
c. a means to image said mail as it is received within said mailbox, said means to image said mail being actuated by a second sensor system;
d. a collection compartment where said mail is stored, said collection compartment being accessible via said exit port;
e. a third sensor system to detect when mail is stored in said collection compartment;
f. a central processing unit, computer memory, and computer readable media;
g. a server remote from and in electronic communication with said receptacle;
h. means to communicate the receipt of mail into said receptacle to a remote user via said server;
i. means to convey said mail to said imaging apparatus;
j. means to communicate an image of mail received into said receptacle to a remote user via said server;
k. means to communicate the storage of mail received into said collection compartment of said receptacle to a remote user via said server;
l. means to communicate the removal of mail housed within said receptacle to a remote user via said server;
m. means to communicate the operational status of said receptacle to a remote user via said server;
n. wherein said entry door of said receptacle opens automatically when said first sensor system is triggered;
o. wherein the movement of said at least one conveyor belt system is paused when triggered by said second sensor system so as to make said received item stationary relative to said imaging system while within the imaging field of said imaging apparatus;
p. wherein said imaging apparatus communicates image data to said central processing unit which facilitates the transmission of said image data to a server for retrieval by an end user;
q. wherein said server communicates electronic notices of the receipt and collection of receptacle housed items to the end users of said receptacle;
r. wherein said exit door is secured and a user is electronically authenticated prior to receiving access to the receptacle interior;
s. wherein a database of authorized end users is stored on said computer readable media;
t. wherein a database of images of said items received by said receptacle are stored and accessible on said server;
u. wherein a database of images of said items received by said receptacle are stored and accessible on said server for communication to an end user and said images of mail in said database are associated with data identifying the recipient and with data identifying the sender;
v. wherein a receptacle access log is maintained on said computer readable memory; and
w. wherein said receptacle is one of a networked plurality of said receptacles.
